(19) United States
(12) Patent Application Publication
(10) Pub. No.: US 2007/0033619 A1
(43) Pub. Date: Feb. 8, 2007

(54) Mobile communication terminal and video on demand service method using the same

(76) Inventors: Kyung Soo Han, Seoul (KR); Young Jin Park, Seoul (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/494,143

(22) Filed: Jul. 26, 2006

(30) Foreign Application Priority Data
Aug. 2, 2005 (KR) 10-2005-0070655

(51) Int. Cl. H04N 7/173; H04N 7/18; H04N 7/16

(52) U.S. Cl. 725/62; 725/86; 725/87; 725/81

(57) ABSTRACT

A mobile communication terminal and a Video On Demand (VOD) service method using the same are provided. The terminal displays information on contents whose playing is stopped so that a user can notice it, facilitates connection and reduces connection time when information required for connection such as an URL of the corresponding contents is stored in a continuous view list and contents are selected without browser connection.

### BACKGROUND OF THE INVENTION

1. Field of the Invention

The present invention generally relates to a mobile communication terminal and an video on demand (hereinafter, referred to as “VOD”) service method using the same, and more specifically, to a technology of displaying information on contents whose play has been stopped so that a user may notice the information in the VOD service in the terminal, thereby enabling the user to select contents easily where a later user wants a continuous view later and enabling the selected contents to perform continuous view playing without connection of an additional browser.

2. Description of the Related Art

As mobile communication terminals have come into wide use, the range of wireless data communication has been expanded through mobile communication terminals. As a result, VOD service for enabling subscribers to watch a desired video at a desired time in a local phone company or a wire TV broadcasting company has been provided through mobile communication terminals.

The mobile communication terminal for supporting the VOD service has a “continuous view” function. The continuous view function asks a user about the continuous view when streaming contents has been stopped in the middle of playing but the same content are re-selected later and re-plays the streaming contents from when the playing has been stopped if the continuous view is selected.

The mobile communication terminal stores in a memory information on a native ID of contents whose play is stopped and on a play timing when play is stopped. Thereafter, when specific contents are selected, whether a native ID of the selected contents exists in the memory is confirmed so that the contents are played from the timing when the play has been stopped depending on the information on the stop timing of the contents corresponding to the native ID.

However, since the conventional mobile communication terminal has not notified users of information on titles, a play time and the stop timing of contents whose play have not been completed, a user has known about information on the play time of corresponding contents after the user connects a browser and performs contents without knowing about information on contents whose play has been stopped.

Moreover, the contents can be played only when a user should connect a browser for the continuous view of the contents whose play has been stopped. As a result, it takes much time, and a user should connect a browser every time when the contents are played.

### SUMMARY OF THE INVENTION

Various embodiments of the present invention are directed at displaying information on titles, an ID and a play time of contents whose play is stopped so that a user can notice them.

Various embodiments of the present invention are directed at storing information required for connection such as URL of the corresponding contents in a continuous view list to perform a continuous view right after the corresponding contents are selected without additional browser connection.

According to an embodiment of the present invention, a mobile communication terminal comprises a memory unit configured to store a continuous view list having information on contents whose play has been stopped and programs for video on demand service, an operation performing unit configured to perform communication, display the continuous view list so that a user may know and drive programs for the video on demand service from the memory unit when contents are selected from the continuous view list so that the continuous view can be directly performed and a control unit configured to set communication environment for the continuous view when the contents are selected, and then controlling to update the continuous view list in the memory unit after the continuous view is completed.

According to an embodiment of the present invention, an video on demand service method of a mobile communication terminal comprises the steps of: storing information of corresponding contents in a continuous view list when play of the contents is stopped in video on demand service; displaying the continuous view list so that a user can notice the list, and performing a continuous view right after contents corresponding to the continuous view is selected from the continuous view list; and updating the continuous view list when play of the continuous view is ended or stopped.

### BRIEF DESCRIPTION OF THE DRAWINGS

Other aspects and advantages of the present invention will become apparent upon reading the following detailed description and upon reference to the drawings in which:

FIG. 1 is a diagram illustrating a VOD service method according to an embodiment of the present invention;

FIG. 2 is a diagram illustrating a mobile communication terminal according to an embodiment of the present invention; and

FIGS. 3 through 5 are flow charts illustrating the VOD service method using the mobile communication terminal in FIG. 2.

### DETAILED DESCRIPTION OF THE EXEMPLARY EMBODIMENTS

The present invention will be described in detail with reference to the accompanying drawings.

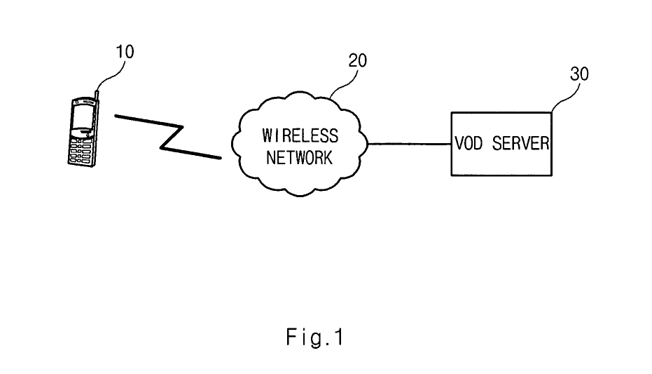

FIG. 1 is a diagram illustrating a VOD service method according to an embodiment of the present invention.

In this embodiment, a VOD server 30 provides video data streaming service through a wireless network 20 to a mobile communication terminal 10.

When a user requests VOD service to the VOD server 30 through the wireless network 20 with the terminal 10, the VOD server 30 provides the VOD service to the terminal 10 through the wireless network 20.

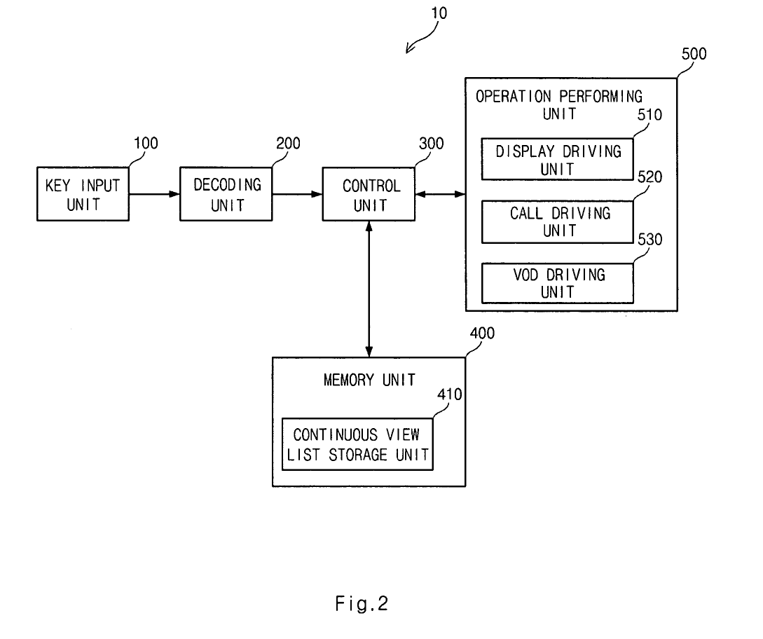

FIG. 2 is a diagram illustrating the mobile communication terminal 10 according to an embodiment of the present invention.

The mobile communication terminal 10 includes a key input unit 100, a decoding unit 200, a control unit 300, a memory unit 400 and an operation performing unit 500.

The key input unit 100 receives external key manipulation to forward a key value it into the decoding unit 200. The decoding unit 200 decodes the key value received from the key input unit 100 to output the decoded key value into the control unit 300.

The control unit 300 reads a program, which is required for performing an operation on the decoded key value outputted from the decoding unit 200, from the memory unit 400 to output the corresponding control value into the operation performing unit 500.

The memory unit 400 stores programs which are required for general operations of the mobile communication terminal 10 and for performing a continuous view. More specifically, a continuous view list storing unit 410 included in the memory unit 400 stores a continuous view list including information of contents whose play is stopped. The information of contents means a native ID, a play time information, titles and a URL of the contents, and the information of contents are stored with a struct type in the continuous view list.

The operation performing unit 500 includes a display driving unit 510, a call driving unit 520 and a VOD driving unit 530. The display driving unit 510 is controlled by the control unit 300 to display the continuous view list in the terminal so that a user can confirm the continuous view list. The call driving unit 520, which is controlled by the control unit 300, drives call, message(short message, multi message) and data communication of the mobile communication terminal 10. The VOD driving unit 530, which is configured to drive VOD service from the VOD server 30, drives a program for the VOD service from the memory 400 when contents are selected from the continuous view list so as to perform a continuous view.

The above-described mobile communication terminal 10 stores information on titles, a URL, a native ID and a play time of the contents in the continuous view list by each title when the playing of the contents is stopped in the middle of VOD streaming playing. The continuous view lists are arranged by each title of the corresponding contents so that the corresponding contents are selected when the title is selected. The continuous view list is stored in the continuous view list storing unit 410.

When a later user intends to play the contents later whose play has been stopped, the user confirms the title of the continuous view list through a contents storing box which is a menu of the mobile communication terminal to select the corresponding contents. Then, the communication connection environment is constructed under control of the control unit 300 so as to be instantly connected to the VOD server 30. As a result, the continuous view playing of the corresponding contents is performed. When the playing is finished, information of the corresponding contents is updated in the continuous view list.

In other words, the corresponding contents are deleted in the continuous view list when the playing is completed, and re-updates information on the stop timing and the play time of the corresponding contents in the continuous view list when the playing is stopped again.

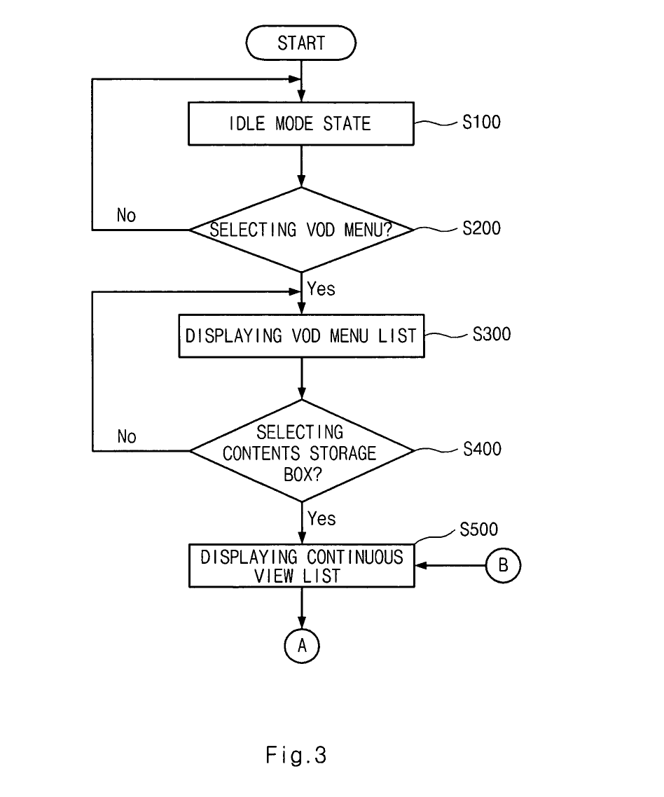

FIGS. 3 through 5 are flow charts illustrating the VOD service method of using the mobile communication terminal in FIG. 2.

FIG. 3 is a flow chart illustrating the continuous view list of the mobile communication terminal 10 to receive VOD service of the mobile communication terminal 10.

In an idle mode state of the mobile communication terminal 10 (S100), the user selects a VOD menu (S200) when the user intents to receive VOD service.

When the VOD menu is selected, menus on the continuous view contents storing box, connection, memory information and environment setting are listed up so that the listed-up menus are displayed on a screen of the terminal (S300). Of these menus, the continuous view contents storing box menu for the continuous view is selected by the user (S400).

Thereafter, when the continuous view contents storing box menu is selected by the user, the continuous view list having information of ID, titles, a play time and a URL of the contents whose play has been stopped is displayed on the screen of the terminal (S500). Preferably, the continuous view list is arranged by each title of the contents, and the corresponding contents are selected when the title is selected.

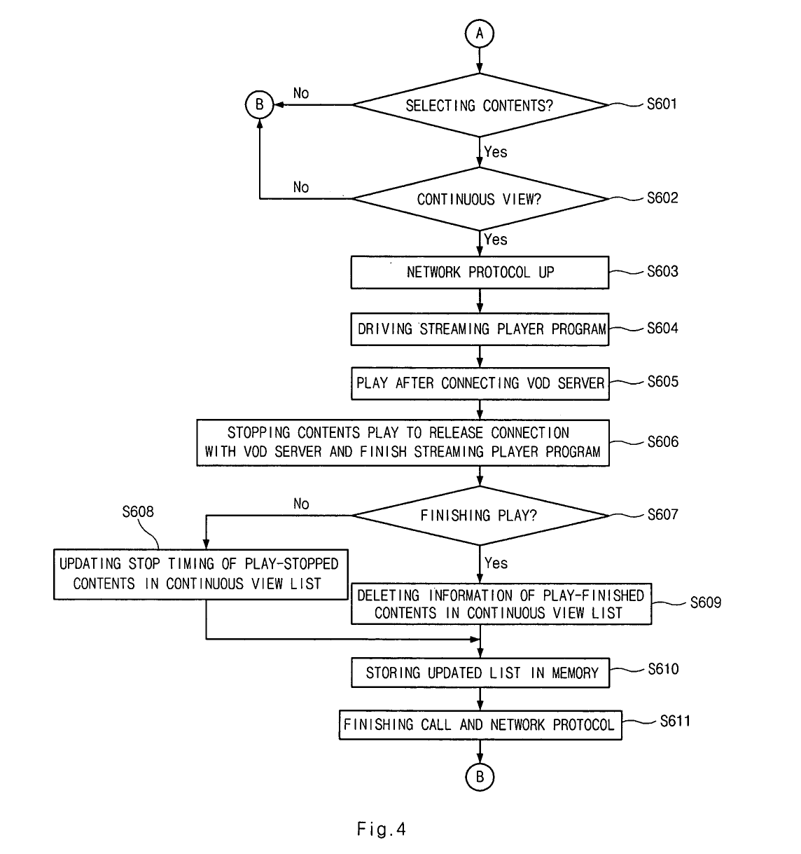

FIG. 4 is a flow chart for updating the continuous view list after the continuous view is performed on the selected contents of the continuous view list.

When the user selects the desired contents from the title of the continuous view list displayed in S500(S601), the question “continuous view?” to ask the continuous view is displayed on the screen of the terminal (S602).

Then, when the user selects the continuous view on the corresponding contents, the control unit 300 opens a traffic channel and ups a network protocol by data call origination (S603).

Thereafter, the control unit 300 drives a streaming player program for performing the continuous view of the contents (S604), and directly connects to the VOD server 30 to play the selected contents continuously from the stop timing (S605).

The control unit 300 confirms the stop timing of the selected contents which are received from the VOD server 30 so that the contents may be played after the stop timing. As a result, the user can perform the continuous view from when the corresponding contents has been stopped.

When the playing of the contents is finished, the control unit 300 releases connection with the VOD server 30, and finishes the streaming player program (S606). The control unit 300 judges whether the playing of the contents is completed or stopped (S607), and updates the play time of the contents whose play is stopped in the continuous view list when the playing is stopped (S608). On the other hand, the control unit 300 deletes information of the contents whose playing is completed in the continuous view list when the playing is finished (S609).

Thereafter, the control unit 300 updates the continuous view list, which is updated in S608 and S609, in the continuous view list storing unit 410 (S610), finishes call and the network protocol (S611).

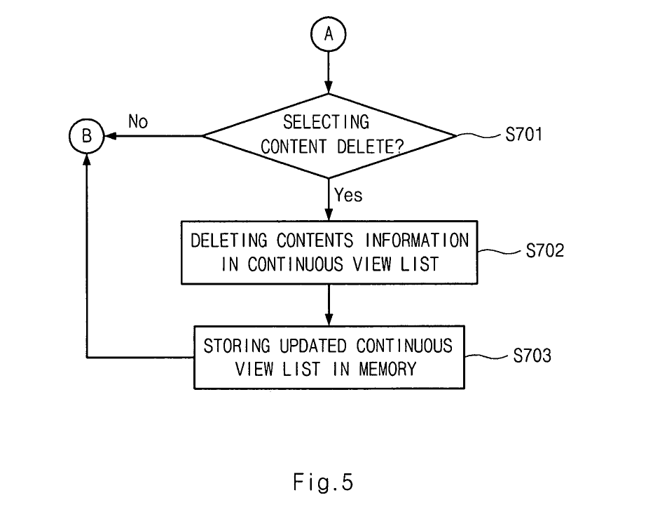

FIG. 5 is a flow chart for updating the continuous view list and deleting contents that a user wants to delete when the user confirms contents information of the continuous view list of FIG. 3 When a user confirms contents information in the continuous view list displayed in FIG. 3 to select the contents that the user wants to delete (S701), the corresponding contents are deleted in the continuous view list (S702). Then, the continuous view list where the corresponding contents are deleted is updated in the continuous view list storing unit 410 (S703).

As described above, a mobile communication terminal according to an embodiment of the present invention displays titles, an ID, a URL and a play time of contents whose playing has been stopped so that a user can notice them, thereby providing the user with a continuous view on contents that the user wants. Furthermore, the terminal facilitates connection and reduces connection time because information required for connection such as an URL of the corresponding contents is stored in a continuous view list and contents are selected without browser connection.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. Thus, the embodiments were chosen and described in order to explain the principles of the invention and its practical application to enable one skilled in the art to utilize the invention in various embodiments and with various modifications as are suited to the particular use contemplated.

What is claimed is:

1. A mobile communication terminal comprising:
a memory unit configured to store a continuous view list having information on contents whose play has been stopped and programs for video on demand service
an operation performing unit configured to perform communication, display the continuous view list so that a user may know and drive programs for the video on demand service from the memory unit when contents are selected from the continuous view list so that the continuous view can be directly performed; and
a control unit configured to set communication environment for the continuous view when the contents are selected, and then controlling to update the continuous view list in the memory unit after the continuous view is completed.

2. The mobile communication terminal according to claim 1, wherein the memory unit stores the continuous view list having information on a title, a URL, an native ID, a stop timing, and play time information of the contents.

3. The mobile communication terminal according to claim 2, wherein the memory unit stores the continuous view list with a struct type.

4. The mobile communication terminal according to claim 2, wherein the control unit makes the continuous view possible with the URL information without connection with an additional browser when contents are selected from the continuous view list.

5. The mobile communication terminal according to claim 4, wherein the control unit confirms a final stop timing of the selected contents so that the contents may be played after the final stop timing.

6. The mobile communication terminal according to claim 2, wherein the control unit judges whether the continuous view of the contents is completed or stopped in the middle of playing to delete contents information corresponding to the continuous view list when the continuous view is completed and to update information of the stop timing of corresponding contents of the continuous view list when the continuous view is stopped.

7. The mobile communication terminal according to claim 2, wherein the operation performing unit comprises:
a display driving unit configured to display information on the contents so that a user can notice them through the continuous view list;
a call driving unit configured to perform call, message and data communication; and
an video on demand service (VOD) driving unit configured to drive a program for the video on demand service when the contents are selected.

8. The mobile communication terminal according to claim 7, wherein the display driving unit classifies the continuous view list by titles of the contents.

9. The mobile communication terminal according to claim 9, wherein the video on demand service driving unit performs the continuous view of the contents when the title of the contents is selected in the continuous view list.

10. The mobile communication terminal according to claim 1, wherein the control unit opens a traffic channel, ups a network protocol by data call origination and sets the communication environment so that a user can perform the continuous view with URL information of each of the contents stored in the continuous view list.

11. An video on demand service method of a mobile communication terminal, the method comprising the steps of:
storing information of corresponding contents in a continuous view list when play of the contents is stopped in video on demand service;
displaying the continuous view list so that a user can notice the list, and performing a continuous view right after contents corresponding to the continuous view is selected from the continuous view list; and
updating the continuous view list when play of the continuous view is ended or stopped.

12. The method according to claim 11, wherein the continuous view list of the storing-information step includes information on a title, an URL, a native ID, a termination timing and play time of the contents.

13. The method according to claim 11, wherein the continuous view list of the storing-information step includes the contents information arranged by each title.

14. The method according to claim 11, wherein the displaying-the-continuous-view step comprises:
setting communication environment for connecting to an video on demand server to up a network protocol when the user selects contents; and
driving a program for the video on demand service and connecting the mobile communication terminal to the video on demand server to perform the continuous view.

15. The method according to claim 14, wherein the setting-communication-environment step constitutes the communication environment when the user selects a title of corresponding contents arranged in the continuous view list.

16. The method according to claim 14, wherein the setting-communication-environment step constitutes the communication environment so that the continuous view can be performed with URL information of each of the contents stored in the continuous view list.

17. The method according to claim 14, wherein the driving-a-program step confirms a final stop timing of the selected contents so that the contents may be played after the final stop timing.

18. The method according to claim 11, wherein the-updating-the-continuous-view-list step includes judging whether the continuous view of the contents is completed or stopped in the middle of playing when the play is finished to delete contents information corresponding to the continuous view list when the continuous view is completed and to update information of a stop timing of contents information of the continuous view list when the continuous view is stopped in the middle of playing.
